(19) United States
(12) Patent Application Publication
(10) Pub. No.: US 2004/0182359 A1
(43) Pub. Date: Sep. 23, 2004

(54) Individual cylinder-switching in a multi-cylinder engine

(76) Inventors: Daniel W. Stewart, Helotes, TX (US); Rudolf H. Stanglmaier, Fort Collins, CO (US); Charles E. Roberts JR., San Antonio, TX (US)

Correspondence Address: Charles W. Hanor, Gunn, Lee, Hanor, P.C., Suite 1500, 700 North St. Mary's Street, San Antonio, TX, 78205, US

(21) Appl. No.: 10/387,597

(22) Filed: Mar. 17, 2003

(51) Int. Cl. F02B 17/00

(52) U.S. Cl. 123/295

(57) ABSTRACT

In a multi-mode, multi-cylinder engine operable in both homogeneous charge compression ignition (HCCI) mode and spark ignition or diesel combustion mode, an apparatus and method is provided to individually, independently, and sequentially switch the combustion mode of each of the cylinders. The invention enables use of at least partial HCCI mode over a wider load and speed range of a multi-mode engine.

### BACKGROUND OF THE INVENTION

1. Field of the Invention

This invention relates generally to a multi-cylinder engine capable of being operated via both homogenous charge compression ignition combustion (HCCI) and spark-ignition or conventional Diesel-mode combustion.

2. Description of the Related Art

HCCI is a mode of combustion in which a substantially homogenous mixture of air, fuel, recycled combustion products, and other diluents in an engine combustion chamber are compressed until it auto-ignites. HCCI is characterized in that ignition is initiated throughout the entire mixture, i.e., multi-point ignition, and proceeds without a visible flame front.

HCCI engines promise to be beneficial for many applications, including both vehicular and stationary installations. HCCI operates at leaner local fuel/air ratios than conventional Diesel-mode engines. The locally leaner mixtures result in lower combustion temperatures, and thus significantly lower levels of nitrous oxides exhaust. The leaner mixtures also result in more complete combustion, and thus fewer partially combusted by-products. Furthermore, because HCCI operates at higher compression ratios than typical spark-ignition (SI) engines, they enjoy high fuel efficiencies. Other HCCI benefits include reduced radiation heat transfer loss and low cycle-by-cycle variation of HCCI combustion.

HCCI is not without disadvantages, however. There are significant challenges in controlling the start and duration (i.e., phase) of HCCI combustion over wide ranges of engine loads and speeds. At very low engine loads, ignition tends to be retarded, which may cause misfire and increased emissions of hydrocarbons and byproducts of partially combusted hydrocarbons. Very high engine loads require richer fuel-air mixtures, which advances the start of combustion (SOC) and increases the rate of combustion. The fast and early combustion causes the engine to knock and run roughly and less efficiently. Moreover, the range of engine loads and speeds over which HCCI combustion is suitable (i.e., does not result in misfire or knocking) is relatively narrow.

Advances have been made in controlling HCCI combustion. U.S. Pat. No. 5,832,880, granted Nov. 10, 1998, to Daniel W. Dickey, one of the co-inventors of the present invention, for an APPARATUS AND METHOD FOR CONTROLLING HOMOGENOUS CHARGE COMPRESSION IGNITION COMBUSTION IN DIESEL ENGINES, and assigned to the assignee of the present invention, controls the start and rate of HCCI combustion with water injection. U.S. Pat. No. 6,041,602, granted Mar. 28, 2000, also to Daniel W. Dickey, titled APPARATUS AND METHOD FOR REDUCING EMISSIONS IN A DUAL COMBUSTION MODE DIESEL ENGINE, and likewise assigned to the assignee of the present invention, teaches the use of a hydraulically-driven turbine mechanically connected to a turbocharger compressor stage to provide additional intake airflow. Additional airflow can be used to increase the air/fuel ratio, thereby decreasing the rate of combustion. U.S. Pat. No. 6,378,489 B1, granted Apr. 30, 2002, to Stanglmaier et al., for METHOD FOR CONTROLLING COMPRESSION IGNITION COMBUSTION, teaches use of two separate fuels having different volatility characteristics to control combustion phasing in a compression ignition engine.

Also, U.S. patent application Ser. No. 09/738,446 was filed on Dec. 15, 2000, by Stefan Simescu, Thomas W. Ryan, III, and Daniel W. Dickey, for ENGINE AND METHOD FOR CONTROLLING HOMOGENOUS CHARGE COMPRESSION IGNITION COMBUSTION IN A DIESEL ENGINE. Thomas W. Ryan, III and Daniel W. Dickey are co-inventors of the present invention, which is likewise assigned to the assignee of the present invention. This application is directed to the control of homogenous charge compression ignition combustion by water injection into the combustion chamber subsequent to sensing an operative characteristic representative of a first combustion stage in the HCCI combustion process. The addition of water after the start of combustion usefully slows down the rate of combustion.

Other approaches to controlling HCCI combustion include U.S. Pat. No. 6,260,520 B1, issued Jul. 17, 2001, to Van Reatherford, which teaches the use of a boost piston and a spark plug to leverage greater control over the start of combustion (SOC). U.S. Pat. No. 6,295,973 B1, issued Oct. 2, 2001, to Yang, teaches the use of a dual air intake and a flow distributor valve to control auto-ignition timing and combustion rate for different engine speeds and loads. U.S. Pat. No. 6,345,610 B1, issued Feb. 12, 2002, also to Yang, teaches partial pre-oxidation of the fuel-air mixture prior to its introduction into the combustion chamber to promote auto-ignition during the compression stroke. U.S. Pat. No. 6,286,482 B1 to Flynn et al., issued Sep. 11, 2001, suggests several different techniques for controlling SOC, the rate of combustion, the duration of combustion, and/or the completion of combustion, including using a plurality of different fuels, varying the compression ratio, adjusting the intake temperature and pressure, and fine-tuning the valve timing.

In spite of these advances, HCCI combustion mode has not yet proven practical at high engine speeds and loads. As the air to fuel ratio is decreased and/or the diluent ratio is reduced, combustion control becomes more difficult, knock-like pressure oscillations appear in the cylinder, and the emissions benefits diminish.

As a practical alternative to full-time HCCI engines, dual-mode engines have been proposed. For example, U.S. Pat. No. 5,875,743, granted Mar. 2, 1999, to Daniel W. Dickey, titled APPARATUS AND METHOD FOR REDUCING EMISSIONS IN A DUAL COMBUSTION MODE DIESEL ENGINE, and assigned to the assignee of the present invention, describes the control of diesel engine emissions in a diesel engine adapted for partial operation in an HCCI combustion mode and partial operation in a diesel mode. Also, U.S. patent application Ser. No. 09/850,189, published Jan. 24, 2002, to Zur Loye et al., teaches a multi-mode internal combustion engine capable of operating in a diesel mode, homogeneous charge dual fuel transition mode, spark ignition or liquid spark ignition mode, and/or a premixed charge compression ignition mode.

Dual-mode engines typically utilize HCCI combustion at low engine loads, and SI or Diesel combustion at moderate and high loads. The benefits of a dual-mode engine are limited by the load range over which HCCI combustion can be employed, and by the duty cycle over which the engine is used. In the current art of dual-mode engines, the power output in HCCI mode is limited to about 25-50% of the full range.

In dual-mode engines, some mechanism must be employed to switch between spark-ignition or Diesel combustion and HCCI combustion. Mode-switching methods depend on the type of engine and HCCI control mechanism used. Such methods include, but are not limited to, intake port deactivation, in-cylinder injection timing, variable valve actuation, and fuel blending. In all existing dual-mode engines known to the inventors, however, when the required power output of the engine exceeds that for which HCCI combustion is suitable, all cylinders are simultaneously switched or phased out of HCCI mode and into SI or Diesel combustion mode.

In U.S. Pat. No. 5,875,743, the hope is expressed that “HCCI combustion mode may be expanded in the future for greater net emissions reduction over the total operating range of the engine.” The present invention is directed to expanding the HCCI combustion mode to attain even greater reduced emissions and fuel efficiency benefits.

### BRIEF SUMMARY OF THE INVENTION

This invention is directed to, but not limited by, one or more of the following non-exhaustive objects, separately or in combination:

to expand the load range over which emissions and/or fuel economy benefits can be obtained in a multi-combustion mode, multi-cylinder engine;

to eliminate more emissions and provide greater fuel efficiency than that which can be attained by simultaneously mode switching all of the cylinders in a multi-combustion mode, multi-cylinder engine; and

to design an engine capable of selectively and independently controlling the air, fuel, temperature, pressure, and diluent inputs of each intake port of a multi-cylinder, multi-combustion mode engine.

Accordingly, a multi-cylinder combustion engine is provided having a plurality of combustion modes and capable of individual cylinder mode switching. The engine comprises first and second combustion chambers, each formed by an engine body and a piston operable to compress a trapped mixture of fuel and air to pressures sufficient to cause the mixture to auto-ignite. The engine further comprises first and second intake ports in fluid communication, respectively, with the first and second combustion chambers. Furthermore, first and second intake port injectors are operable to inject fuel into the first and second intake ports, respectively. A controllable source of air, including oxygen, is in fluid communication with the first and second intake ports. The combination of intake port injectors and intake ports enables substantially homogenous mixtures of fuel and air to be developed prior to delivery of the mixtures to the combustion chambers. The engine also comprises first and second in-cylinder injectors operable to inject fuel directly into the first and second combustion chambers respectively. These in-cylinder injectors enable the engine to operate in non-HCCI mode (i.e., using nonhomogeneous mixtures of fuel and air) when advantageous to do so.

The engine further comprises a sensor that senses engine operating conditions indicative of the engine speed and load, and an engine control unit communicatively coupled to the sensor, the in-cylinder injectors and the intake port injectors. The engine control unit is operable to control the volume and timing of fuel injected into the in-cylinder injectors and the intake port injectors. The engine control unit is also adapted to deliver electronic signals to controllably deliver fuel through the first and second intake port injectors in amounts and times sufficient to form substantially homogeneous mixtures of fuel and air in the first and second combustion chambers in response to sensing engine operating conditions indicative of engine speed and load values within a first predefined range. The engine control unit is further adapted to deliver fuel through the first and second in-cylinder injectors in amounts and times sufficient to form substantially nonhomogeneous mixtures of fuel and air into the first and second combustion chambers in response to sensing engine operating conditions indicative of engine speed and load values within a second predefined range. The engine control unit is yet further adapted to deliver fuel through the first intake port injector in an amount and time sufficient to form a substantially homogeneous mixture of fuel and air in the first combustion chamber while at the same time delivering fuel through the second in-cylinder injector in an amount and time sufficient to form a substantially nonhomogeneous mixture of fuel and air into the second combustion chamber in response to sensing engine operating conditions indicative of engine speed and load values within a third predefined range intermediate the first and second ranges.

In a preferred embodiment, the engine control unit is communicatively coupled with a controllable source of air and is operable to independently control the air flow entering the first and second intake ports. Furthermore, the engine preferably comprises a first exhaust port in fluid communication with the first combustion chamber; an exhaust gas recirculation port fluidly connecting the first exhaust port to the controllable source of air; a first exhaust gas recirculation valve that governs the egress of exhaust gas from the first exhaust port to the exhaust recirculation gas port; a second exhaust port in fluid communication with the second combustion chamber, and a second exhaust gas recirculation valve to permit the egress of gas from the second exhaust port into the exhaust gas recirculation port. Also, the controllable source of air preferably comprises a first exhaust gas inlet valve fluidly connecting the exhaust gas recirculation port to the first intake port to govern the reintroduction of exhaust gas into the first intake port and a second exhaust gas inlet valve fluidly connecting the exhaust gas recirculation port to the second intake port to govern the reintroduction of exhaust gas into the second intake port. Furthermore, the engine control unit is preferably communicatively coupled to each of the exhaust gas recirculation valves, the engine control unit being adapted to deliver signals to open exhaust gas recirculation valves in fluid communication with combustion chambers that are operating in substantially homogeneous charge compression ignition mode and to close exhaust gas recirculation valves in fluid communication with combustion chambers that are not operating in substantially homogeneous charge compression ignition mode.

Furthermore, a method is provided for controlling the combustion mode of a multi-mode combustion engine having a plurality of cylinders. The method comprises phasing a first of said plurality of combustion chambers from a first combustion mode to a second combustion mode, phasing a second of said plurality of combustion chambers from the first combustion mode to the second combustion mode, wherein the phasing of the first combustion chamber is not simultaneous with the phasing of the second combustion chamber, and wherein one of the first and second combustion modes is substantially homogeneous charge compression ignition, and the other of the first and second combustion modes is drawn from a group consisting of spark ignition and non-homogeneous compression ignition.

In one embodiment of the method, the phasing of the second combustion chamber begins after the phasing of the first combustion chamber has begun. In another, the phasing of the second combustion chamber is completed after the phasing of the first combustion chamber has been completed. In yet another embodiment, the phasing of the second combustion chamber begins after the phasing of the first combustion chamber has been completed.

Alternatively, a method is provided for controlling the combustion mode of a multi-mode combustion engine having a plurality of combustion chambers, the method comprising switching a first of said plurality of combustion chambers from a first combustion mode to a second combustion mode, switching a second of said plurality of combustion chambers from the first combustion mode to the second combustion mode, wherein the switching of the first combustion chamber is not simultaneous with the switching of the second combustion chamber, and wherein one of the first and second combustion modes is substantially homogeneous charge compression ignition, and the other of the first and second combustion modes is drawn from a group consisting of spark ignition and non-homogeneous compression ignition.

Other aspects, objects, features, and advantages of the present invention will be readily apparent to those skilled in the art in light of the following description.

### BRIEF DESCRIPTION OF THE SEVERAL VIEWS OF THE DRAWINGS

A more complete understanding of the structure and operation of the present invention may be had by reference to the following detailed description when taken in conjunction with the accompanying drawings, wherein:

FIG. 1 is a schematic representation of one embodiment of a multi-cylinder engine with individual multi-mode switching control in accordance with the present invention.

FIG. 2 is a flow chart illustrating an incremental transition of cylinders in a multi-cylinder engine from HCCI mode to spark-ignition or Diesel mode.

FIG. 3 is a flow chart illustrating an alternative incremental transition of cylinders in a multi-cylinder engine from HCCI mode to spark-ignition or Diesel mode.

FIG. 4 is a graph representing a diesel engine speed and load operating range, with representative areas identified for different combustion modes, in accordance with the apparatus and method embodying the present invention.

### DETAILED DESCRIPTION OF THE INVENTION

The method of combustion known as Homogeneous Charge Compression Ignition (HCCI), and alternatively referred to as pre-mixed charge compression ignition (PCCI), is hereinafter collectively referred to as HCCI. HCCI mode is characterized in that (1) an air-fuel mix is combustible by compression ignition; and (2) the vast majority of fuel in the combustible air-fuel mixture is sufficiently pre-mixed so that ignition is very nearly simultaneously initiated at several points throughout the mixture, so that combustion proceeds without a visible flame front. Preferably, the fuel-to-air ratio is much leaner than stoichiometry or with a high percentage of EGR so that more complete combustion of the fuel is achieved, thereby significantly reducing emissions. The timing of fuel delivery in HCCI mode at pre-ignition temperatures does not significantly impact the timing of ignition. It should be understood that HCCI mode encompasses fuel mixtures that are less than completely homogeneous, including fuel mixtures that have a small degree of stratification.

HCCI has the potential to dramatically reduce nitrous oxide and particulate matter emissions because the mixture of fuel and air can be substantially uniformly mixed to lean and/or dilute levels before combustion of the mixture. The HCCI combustion mode, and methods for controlling combustion in that mode, are described in detail in U.S. Pat. Nos. 6,286,482 B1; 5,875,743; and 5,832,880, which are herein incorporated by reference in their entireties for all purposes. However, heretofore, no apparatus or method has been taught for individually and independently transitioning combustion chambers of a multi-cylinder engine between HCCI mode and other combustion modes, such as spark ignition (SI) or conventional diesel ignition (DI) mode, in order to increase the speed and load range in which a multi-mode engine operates at least some of its cylinders in HCCI mode. As used in this specification, SI refers to a cycle in which the start of combustion is controlled by the timing of an electrical spark. DI refers to ignition through compression of a non-homogeneous charge.

The present invention provides an apparatus and method for individual cylinder combustion mode-switching, so that one or more cylinders of a multi-cylinder engine can be operated on HCCI mode at the same time the remaining cylinders are operated on SI or DI mode.

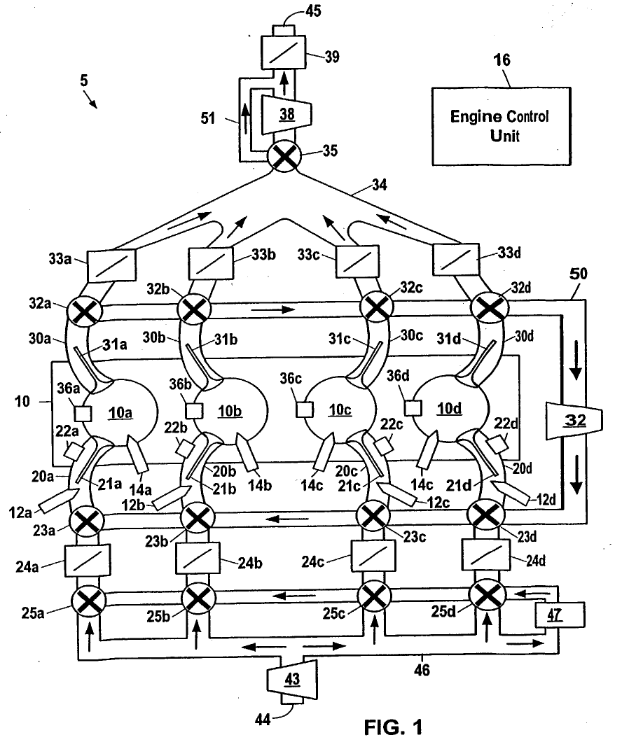

FIG. 1 schematically represents one embodiment of a multi-cylinder engine apparatus 5 with individual multi-mode switching control in accordance with the present invention. Engine apparatus 5 comprises an engine block 10 having four cylinders or combustion chambers 10a, 10b, 10c and 10d. It will be understood that the embodiment depicted could be easily adapted to any engine having two or more cylinders. Each cylinder 10a, 10b, 10c and 10d is formed by an engine body and a piston (not shown) operable to compress a trapped mixture of fuel and air to pressures and temperatures sufficient to cause the mixture to auto-ignite. Each cylinder 10a, 10b, 10c and 10d may optionally include an additional piston (not shown) to provide even greater control over the timing of compression ignition, as taught in U.S. Pat. No. 6,260,520 B1, which is hereby incorporated by reference for all purposes.

In-cylinder injectors 14a, 14b, 14c and 14d are disposed to inject fuel and/or a diluent directly into respective cylinders 10a, 10b, 10c and 10d. It will be understood that injectors 14a, 14b, 14c and 14d may comprise single injection or multiple (e.g., dual fluid) nozzles. Also, additional in-cylinder injectors (not shown) may also be disposed to inject the same or a secondary fuel and/or a diluent directly into the cylinder 10a, 10b, 10c and 10d. In addition, spark plugs (not shown) may be disposed in cylinders 10a, 10b, 10c and 10d to operate the cylinders in SI mode or to influence the SOC in another combustion mode.

Engine apparatus 5 is also provided with individual intake ports 20a, 20b, 20c and 20d in fluid communication with cylinders 10a, 10b, 10c and 10d, respectively. Air, or a mixture of fuel and air, or a mixture of fuel, air, and diluents (such as recirculated exhaust gas, nitrogen, and/or water), is introduced into each cylinder 10a, 10b, 10c and 10d through its respective intake port 20a, 20b, 20c and 20d. Each cylinder 10a, 10b, 10c and 10d is provided with an intake valve 21a, 21b, 21c and 21d to mediate and regulate the timing, volume, and flow rate of the air or mixture communicated from the intake port 20a, 20b, 20c or 20d to the cylinder 10a, 10b, 10c or 10d.

In a preferred embodiment, engine apparatus 5 is provided with intake port injectors 12a, 12b, 12c and 12d that are individually operable to inject fuel into respective intake ports 20a, 20b, 20c and 20d. The intake port injectors 12a, 12b, 12c and 12d function to create mixtures of fuel and air before the mixtures are introduced into their respective chambers 10a, 10b, 10c and 10d. The turbulence effected by the injection and physical geometry of the intake port 12a, 12b, 12c and 12d, and/or the turbulence caused by the valve-controlled introduction of the mixtures into their respective chambers 10a, 10b, 10c and 10d, serve to mix the fuel and air into substantially homogenous charges. In a preferred mode of operation, a cylinder 10a, 10b, 10c or 10d in HCCI mode operates with the in-cylinder injector 14a, 14b, 14c or 14d turned off, and the port injector 12a, 12b, 12c or 12d is activated to create a substantially homogeneous charge fuel and air.

Other embodiments, not depicted in FIG. 1 but still considered to be within the scope of the present invention, could substitute a single or multiple carburetors for the injectors 12a, 12b, 12c and 12d. Yet further embodiments, also considered to be within the scope of the present invention, dispense with either the intake port injectors 12a, 12b, 12c and 12d or carburetors, and instead utilize only direct in-cylinder injections of fuel to create substantially homogeneous charges within the cylinders prior to combustion. In such embodiments, the physical geometry of the cylinders 10a, 10b, 10c, 10d, and/or the location of the in-cylinder injectors 14a, 14b, 14c, 14d or secondary in-cylinder injectors (not shown), and/or the physical geometry of one or more pistons (not shown) within the cylinders 10a, 10b, 10c, 10d, and/or the timing of fuel injection and piston movement, is/are used to create substantially homogeneous charges within the cylinders prior to combustion.

Engine apparatus 5 is also provided with individual exhaust ports 30a, 30b, 30c and 30d in fluid communication with cylinders 10a, 10b, 10c and 10d, respectively. The products of combustion are permitted to escape each cylinder 10a, 10b, 10c and 10d through its respective exhaust port 30a, 30b, 30c and 30d. Each cylinder 10a, 10b, 10c and 10d is also provided with an exhaust valve 31a, 31b, 31c and 31d to mediate and regulate the timing, volume, and flow rate of the products of combustion communicated from the cylinder 10a, 10b, 10c or 10d to the exhaust port 30a, 30b, 30c or 30d.

A preferred embodiment, depicted in FIG. 1, utilizes exhaust gas recirculation (EGR) in the HCCI mode to control the start of combustion (SOC) in the HCCI mode. EGR is optionally also used in the SI and/or DI modes to reduce nitrous oxide emissions. In FIG. 1, EGR is regulated by a plurality of EGR exhaust valves 32a, 32b, 32c and 32d and a plurality of EGR intake valves 23a, 23b, 23c and 23d. Each EGR exhaust valve 32a, 32b, 32c and 32d is preferably a one-way valve in communication with a common EGR duct 50 and is disposed, respectively, in or adjacent respective exhaust port 30a, 30b, 30c and 30d. In this manner, the products of combustion can be selectively introduced from each exhaust port 30a, 30b, 30c and 30d into the EGR duct 50. Likewise, each EGR intake valve 23a, 23b, 23c and 23d is preferably also a one-way valve in communication with the common EGR duct 50 and is disposed, respectively, in or adjacent respective intake port 20a, 20b, 20c and 20d. In this manner, the recirculated exhaust gas can be selectively introduced from the EGR duct 50 into each intake port 20a, 20b, 20c and 20d.

Significantly, the provision of selectively controllable EGR exhaust valves 32a, 32b, 32c and 32d enables control over the quality of exhaust gas introduced into the EGR duct 50. In some cases, it may be desirable to reduce the level of particulates and nitrous oxides introduced into the EGR duct 50, because such products may gum up and/or corrode engine components. This can be effected, for example, by opening those EGR exhaust valves 32a, 32b, 32c and/or 32d disposed within exhaust ports 30a, 30b, 30c and/or 30d that carry the products of HCCI combustion, but closing those EGR exhaust valves 32a, 32b, 32c and/or 32d disposed within exhaust ports 30a, 30b, 30c and/or 30d that carry the products of regular SI or DI combustion. Of course, if this is not a concern, or if other means are utilized to reduce the level of particulates and nitrous oxides, EGR exhaust valves 32a, 32b, 32c and 32d may not be needed and may be eliminated from such embodiments or substituted with a common EGR valve.

Also significantly, the provision of selectively controllable EGR intake valves 23a, 23b, 23c and 23d enables selective control over whether, when, and to what extent recirculated exhaust gas is introduced into each intake port 20a, 20b, 20c and 20d. This facilitates individual control over the temperature, quality, and components of the fuel-air mixture in each intake port 20a, 20b, 20c and 20d, which in turn influences the timing and duration of combustion of cylinders 10a, 10b, 10c and 10d operated in HCCI mode, as well as the emissions levels of cylinders 10a, 10b, 10c and 10d operated in SI or DI mode.

FIG. 1 also depicts an EGR pump 32 that mediates the pressure and flow of exhaust gas within the EGR duct 50 to control the pressure of EGR gas introduced into each intake port 20a, 20b, 20c and 20d. EGR pump 32 may be powered by any suitable means, such as by a hydraulically driven turbine, as explained and depicted in U.S. Pat. No. 6,041,602, which is herein incorporated by reference in its entirety for all purposes.

Although not depicted in FIG. 1, even more sophisticated embodiments of the invention include one or more additional EGR ducts. For example, a first EGR duct may be provided to carry exhaust gas from HCCI combustion; and a second EGR duct may be provided to carry exhaust gas from SI or DI combustion. In such an embodiment, EGR exhaust valves 32a, 32b, 32c and 32d, or additional EGR exhaust valves (not shown) would be controlled to selectively release exhaust gas into the first and second EGR ducts depending on the combustion mode of the corresponding cylinder 10a, 10b, 10c and 10d. EGR intake valves 23a, 23b, 23c and 23d, or additional EGR intake valves (not shown) would selectively introduce exhaust gas from the first and second EGR ducts. Significantly, such an embodiment would enable even further control over the temperature and diluent ratio of the fuel-air charges in intake ports 20a, 20b, 20c and 20d.

Engine apparatus 5 is also optionally provided with individual and independently selectable exhaust restriction throttles 33a, 33b, 33c and 33d in fluid communication with exhaust ports 30a, 30b, 30c and 30d, respectively. The exhaust restriction throttles 33a, 33b, 33c and 33d serve to regulate pressures within the exhaust ports 30a, 30b, 30c and 30d, thereby providing selective control over the residual mass fraction (i.e., the proportion of trapped residuals to fresh charge) in each cylinder 10a, 10b, 10c and 10d. As taught in U.S. Pat. No. 6,286,482 B1, which has been incorporated by reference for all purposes, increasing the residual mass fraction can be used to advance HCCI ignition.

The outflow of each exhaust port 30a, 30b, 30c and 30d converges within exhaust manifold 34 and ultimately escapes engine apparatus 5 at point 45. An exhaust turbine 38, such as the exhaust turbine of the turbocharger depicted in U.S. Pat. No. 6,041,602, which has been incorporated by reference, may be provided. Furthermore, a turbine bypass circuit 51 and exhaust bypass valve 35 are optionally provided to regulate the exhaust gas pressure as well as the amount of mechanical power provided to the exhaust turbine 38. A preferred embodiment of the invention includes an exhaust gas treatment device 39 to catalyze various byproducts of combustion in the exhaust gas and thereby further reduce unwanted emissions.

On the intake side, engine apparatus 5 is provided with a compressor 43, which is optionally mechanically linked, via a shaft (not shown), with exhaust turbine 38, as depicted in U.S. Pat. No. 6,041,602. The compressor 43 draws air from an external source (such as the outside environment) at point 44 and discharges it into intake manifold 46. The compressor 43 serves to boost the intake pressure 38, which advantageously permits an increase in the air-to-fuel ratio to reduce emissions and also improves the transient performance of an engine under changing load conditions.

The air in intake manifold 46 is then channeled into the individual intake ports 20a, 20b, 20c and 20d. In a preferred embodiment, individual and independently selectable intake throttles 24a, 24b, 24c and 24d are disposed intermediate the intake manifold 46 and the individual intake ports 20a, 20b, 20c and 20d in order to selectively regulate the pressure in each intake port 20a, 20b, 20c and 20d. Upstream of the throttles 24a, 24b, 24c and 24d, a portion of the air introduced into each intake port 20a, 20b, 20c and 20d is optionally cooled or preheated by an air temperature regulator 47. Air temperature regulator 47 is optionally an air cooler, an air heater, or a combination of each. The proportion of regular intake air to temperature-treated air introduced into each intake port 20a, 20b, 20c and 20d is individually and independently controlled by intake air valves 25a, 25b, 25c and 25d. In the embodiment depicted in FIG. 1, the intake air valves 25a, 25b, 25c and 25d are disposed downstream of compressor 43 and upstream of intake throttles 24a, 24b, 24c and 24d. In an alternative embodiment (not shown), the intake air valves 25a, 25b, 25c and 25d are disposed downstream of intake throttles 24a, 24b, 24c and 24d.

FIG. 1 also depicts one or more sensors 36a, 36b, 36c and 36d disposed within each combustion chamber 10a, 10b, 10c and 10d; as well as one or more sensors 22a, 22b, 22c and 22d disposed within each intake port 20a, 20b, 20c and 20d. Each sensor is communicatively coupled, preferably through wires (not shown) carrying electronic signals, or alternatively through other modes of communication, including fiber-optic light communicating mediums, wireless electromagnetic signals, and pneumatic pressure, to an engine control unit (ECU) 16. Sensors 36a, 36b, 36c and 36d preferably comprise any one or more of a knock sensor (to provide a feedback signal to the ECU 16 to avoid damaging engine lock), a start-of-combustion sensor (to detect premature or late start of combustion in the corresponding combustion chamber), a pressure sensor, a temperature sensor, an air quality sensor, and additional sensors to sense the rate and duration of combustion.

Likewise, sensors 22a, 22b, 22c and 22d preferably comprise any one or more of intake port temperature sensor, an intake port pressure sensor, and an air quality sensor (to sense the amount of one or more diluents and/or the relative proportions of one or more gases). Any suitable form of sensor may be used, including but not limited to accelerometers, ion probes, optical diagnostics, strain gauges, and fast thermocouples in the cylinder head, liner or piston. 1

Preferably, several other sensors, not shown (to prevent overcrowding of FIG. 1), are also utilized. For example, one or more coolant sensors are preferably provided to signal the temperature of engine coolant circulating through the engine and radiator. Also, an engine speed sensor and/or piston position sensor, as described in U.S. Pat. No. 5,875,743, is preferably provided to measure the engine's speed. An engine load or torque sensor may be provided to measure the engine's load. Emissions sensors may be provided in the exhaust ports 30a, 30b, 30c and 30d, the EGR port 50, the exhaust gas manifold 34, and/or at exit point 45, to monitor the completeness of combustion and/or quality of emissions. Additional temperature and pressure sensors may be disposed in the intake manifold 46; in the intake ports 20a, 20b, 20c and 20d upstream of the throttles 24a, 24b, 24c and 24d; in the EGR port 50 upstream and/or downstream of compressor 32; in the exhaust ports 30a, 30b, 30c, and 30d, in the exhaust manifold 34, and/or in the turbine bypass circuit 51. The signals from these sensors are provided to the ECU 16.

The ECU is of the type commonly used to control various engine operating parameters, that is, it includes a central processing unit such as a micro-controller, micro-processor, or other suitable computing unit. The ECU 16 is communicatively coupled by suitable means (preferably by conductive wire or light-carrying optical fibers) and through appropriate transducers to the in-cylinder injectors 14a, 14b, 14c and 14d; the intake port injectors 12a, 12b, 12c and 12d (if provided); the EGR exhaust valves 32a, 32b, 32c and 32d (if provided); the EGR intake valves 23a, 23b, 23c and 23d (if provided); the exhaust restriction throttles 33a, 33b, 33c and 33d (if provided); the intake throttles 24a, 24b, 24c and 24d (if provided); the bypass valve 35 (if provided); the intake air valves 25a, 25b, 25c and 25d; and the air temperature regulator 47. The ECU 16 is also preferably communicatively coupled with the intake valves 21a, 21b, 21c and 21d; and/or the exhaust valves 31a, 31b, 31c and 31d. Alternatively, the open-and-close operation of such valves is controlled mechanically through mechanical couplings to the crankshaft.

The ECU 16 sends signals to injectors 12a, 12b, 12c, 12d, 14a, 14b, 14c and 14d to selectively and independently control the timing, quantity, and type (if multiple types of fuel are provided) of fuel injection in each intake port 20a, 20b, 20c and 20d and combustion chamber 10a, 10b, 10c and 10d. The ECU 16 also sends signals to EGR exhaust valves 32a, 32b, 32c and 32d and EGR intake valves 23a, 23b, 23c and 23d to selectively and independently control the timing, flow rate, quality, and optionally also the temperature of recirculated exhaust gas introduced into intake ports 20a, 20b, 20c and 20d. The ECU 16 is also optionally communicatively coupled with EGR pump 32 to thereby provide additional control over the pressure of recirculated exhaust gas introduced into intake ports 20a, 20b, 20c and 20d.

The ECU 16 also provides signals to exhaust throttles 33a, 33b, 33c and 33d (if provided) to selectively and independently control the residual mass fraction in each of the cylinders 10a, 10b, 10c and 10d. The ECU 16 also provides signals to the intake throttles 24a, 24b, 24c and 24d to selectively and independently control the intake air or air-fuel charge pressure in each of the intake ports 20a, 20b, 20c and 20d. The ECU 16 also provides signals to intake air valves 25a, 25b, 25c and 25d to selectively and independently control the temperature of the air or air-fuel mixture introduced into the intake ports 20a, 20b, 20c and 20d.

For all the components controlled by the ECU 16, the ECU's control of such injectors is based upon specific values of sensed parameters. The sensed values may be mapped to one or more look-up tables or state machines in the ECU 16 to determine the manner in which the ECU 16 operates and coordinates the various components that it controls. Alternatively, the ECU may utilize neural network techniques of a type known and understood by those skilled in the art of neural networks to effectively “learn” more optimal operating parameters over time.

It will be understood that the invention includes and encompasses embodiments that omit, modify, substitute, or enhance one or more of the components depicted in FIG. 1 and used to control the temperature, pressure, composition, and other characteristics of the air-fuel mixture entering the combustion chambers 10a, 10b, 10c and 10d, as well as the products of combustion exiting it. The invention should be understood to also include and encompass embodiments that include other refinements not shown or depicted in FIG. 1. For example, additional components may be added to introduce separate fuels into the combustion chamber to control the combustion phasing. Yet further components may be added to distill a portion of a parent fuel into a separate fuel characterized by a different reactivity, as taught and depicted in U.S. Pat. No. 6,378,489 B1, which is herein incorporated by reference in its entirety for all purposes. Alternatively, modifications to the intake ports 20a, 20b, 20c and 20d as shown in U.S. Pat. No. 6,345,610 B1, which is also herein incorporated by reference in its entirety for all purposes, may be perfected in order to selectively and independently partially oxidize fuel-air charges prior to their introduction into the combustion chambers 10a, 10b, 10c and 10d. Those skilled in the art will appreciate yet further ways in which the teachings of this invention can be applied to individually, independently, and selectively control the temperature, pressure, composition, and other characteristics of the air-fuel mixture entering the combustion chambers 10a, 10b, 10c and 10d, as well as the products of combustion exiting it.

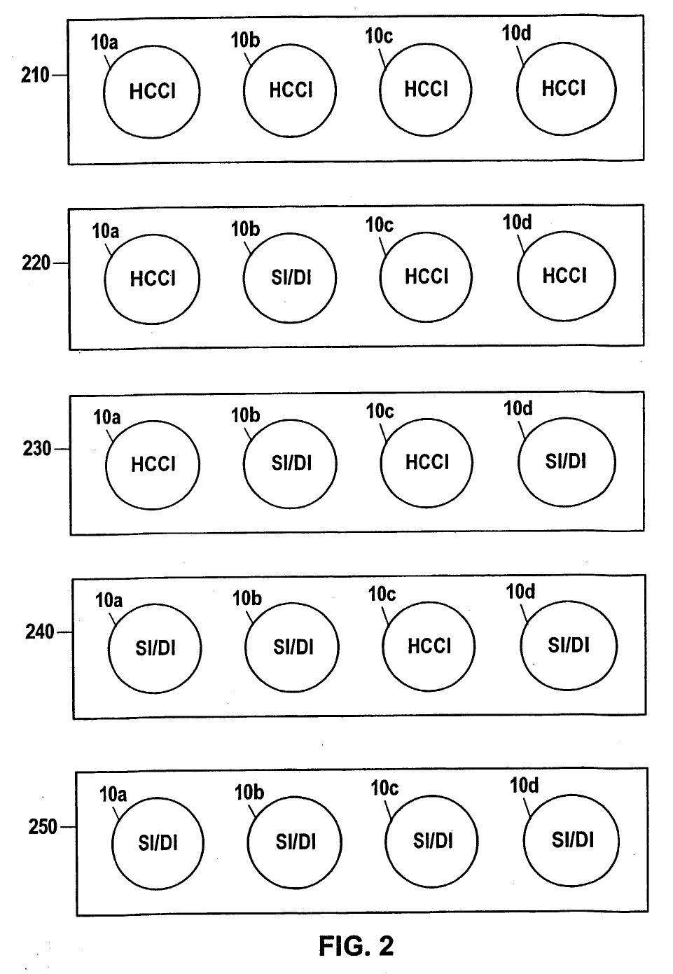

FIG. 2 is a flow chart illustrating an incremental transition of cylinders 10a, 10b, 10c and 10d in the multi-cylinder engine apparatus 5 of FIG. 1 from HCCI mode to spark-ignition or Diesel mode. In all-HCCI operation 210, all four cylinders 10a, 10b, 10c and 10d operate in HCCI mode. Incrementally higher output power is supplied through HCCI-dominant operation 220, which depicts cylinders 10a, 10c and 10d in HCCI mode while cylinder 10b is in SI or DI mode. Yet higher output power is supplied through equi-modal operation 230, which depicts cylinders 10a and 10c in HCCI mode while cylinders 10b and 10d are in SI or DI mode. Even further output power is supplied in SI/DI-dominant mode 240, which depicts cylinder 10c in HCCI mode, while the other three cylinders 10a, 10b and 10d operate in SI/DI mode. Finally, maximum output power is supplied by all-SI/DI operation 250, which depicts all four cylinders 10a, 10b, 10c and 10d in SI or DI mode.

The operations 210, 220, 230, 240, and 250 are exemplary of a four-cylinder engine. Additional operations would be available for engines with additional cylinders. Likewise, fewer operations would be available for engines with fewer cylinders. Moreover, the sequence depicted by FIG. 2 in which individual cylinders 10a, 10b, 10c, and 10d are switched from HCCI mode to SI/DI mode (cylinder 10b, then cylinder 10d, then cylinder 10a, then cylinder 10d) is exemplary. The individual cylinders 10a, 10b, 10c and 10d may be switched in a different sequence. However, it may be expected that differentials in the operating characteristics of the individual cylinders 10a, 10b, 10c and 10d may favor one switching progression over another.

It should also be understood that each cylinder 5 may be operated to switch cleanly between HCCI mode and SI or DI mode, or alternatively, to phase gradually between the modes. In phased operation, a substantially homogeneous air-fuel charge may be introduced into a cylinder 10a, 10b, 10c or 10d and fuel be introduced through an in-cylinder injector 14a, 14b, 14c or 14d, causing the cylinder 10a, 10b, 10c or 10d to operate in two combustion modes in a single compression stroke and power stroke cycle. Apparatuses and methods for simultaneously operating a cylinder in two combustion modes are described in U.S. Pat. No. 5,740,775, issued Apr. 21, 1998, and U.S. patent application Ser. No. 09/850,189, published on Jan. 24, 2002, both of which are herein incorporated by reference in their entireties for all purposes.

Preferably, the engine apparatus 5 operates with all four cylinders 10a, 10b, 10c and 10d in the HCCI mode when the speed and load conditions are conducive to all-HCCI operation 210. When the ECU 16 senses an increasing load demand, the ECU 16 switches or phases a single combustion chamber 10a, 10b, 10c or 10d from HCCI mode to SI/DI mode, so that the engine, as a whole, progresses from the all-HCCI operation 210 to the HCCI-dominant operation 220. Further load and speed demands trigger additional incremental transitions from the HCCI-dominant operation 220 to the equi-modal operation 230 to the SI/DI-dominant operation 230 and finally to the all-SI/DI operation 240. The rate of progression from one operation 210, 220, 230, 240 to the next depends on the magnitude of the increased speed and load demands of the engine apparatus 5. The ECU 16 may skip one or more of modes 220, 230, and 240 if the speed and load demands of the engine apparatus 5 transition quickly enough.

Advantageously, low emissions benefits can be obtained not only in all-HCCI operation 210, but also in HCCI-dominant operation 220, equi-modal operation 230, and SI/DI dominant operation 240. Through selective control of the EGR exhaust valves 32a, 32b, 32c and 32d (e.g., to favor recirculation of the cleaner exhaust emitted by cylinders operating in the HCCI mode), the low emissions benefits may even be disproportionately greater than the ratio of cylinders operating in the HCCI mode to cylinders operating in SI/DI mode.

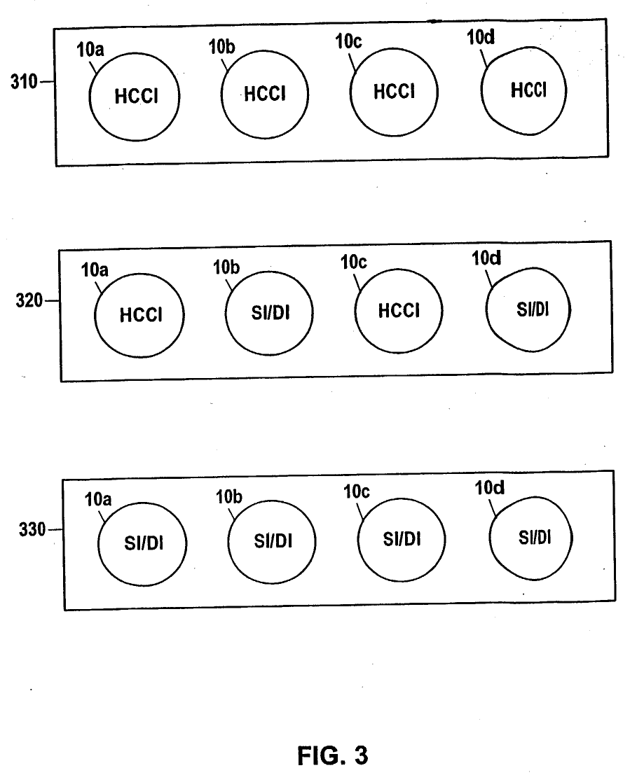

FIG. 3 is a flow chart illustrating an alternative incremental transition of four cylinders of a multi-cylinder engine from HCCI mode to spark-ignition or Diesel mode. In this embodiment, two or more cylinders 10a, 10b, 10c and 10d are switched or phased from HCCI mode to SI/DI mode at a time in order to more evenly distribute the load borne by the individual cylinders 10a, 10b, 10c and 10d. It will be understood that cylinders 10a, 10b, 10c and 10d operating in a SI/DI mode will provide more torque and/or horsepower than cylinders 1a, 10b, 10c and 10d operating in a HCCI mode. Mismatches in cylinder performance have been known to cause an engine to operate roughly, particularly at low engine speeds. By distributing those mismatches more evenly, it is believed that smoother engine operation can be achieved. Thus, in a four cylinder engine as depicted in FIG. 3, a transition is made from an all-HCCI operation 310 to an equi-modal operation 320 (in which alternate cylinders are kept in HCCI operation) to an all-SI/DI operation 330. In a six-cylinder engine, progression may be in made by first switching the even cylinders, and then the odd cylinders from HCCI to all-SI/DI mode; or alternatively by switching first the first and fourth cylinders, and then the second and fifth cylinders, and then the third and sixth cylinders.

It should also be understood that while FIGS. 2 and 3 have been described in terms of transitioning from HCCI mode to SI/DI mode, the principles of the present invention are equally applicable to transition from SI/DI mode to HCCI mode and, indeed, between any two modes of a multi-modal engine.

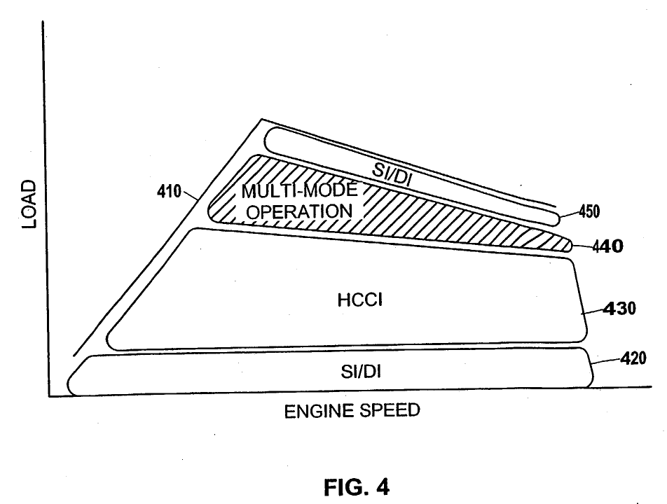

The graph of FIG. 4 represents a diesel engine speed and load operating range for a multi-modal engine built in accordance with the present invention. A conventional diesel or spark ignition engine is typically capable of operating over a relatively broad speed and load range. For example, a typical speed and load range of a diesel engine is represented in FIG. 4 by solid straight lines 410. Load values increase as speed increases, up to a maximum load value, after which with continued increase in engine speed, the load values, i.e., the torque characteristics, of the engine gradually decrease. The various desirable modal operations for an engine equipped with the apparatus 5 embodying the present invention, are defined by separately inscribed areas under the load-speed curve 410. The lower area identified by reference numeral 420, and labeled “SI/DI,” represents the conventional diesel or spark ignition mode operation over the entire operating speed range of the engine, and at relatively low loads. At more moderate loads, as represented by area 430 labeled “HCCI,” conditions conducive for all-HCCI operation are present. At very high loads, as represented by area 430 labeled “SI/DI,” conditions best supported by all-SI/DI operation are present. At moderately high loads, as represented by area 440 labeled “MULTI-MODAL OPERATION,” conditions conducive to partial-HCCI operation and partial-SI/DI operation are present.

Thus, FIG. 4 is an engine map showing the speed and loads where conventional spark ignition or diesel combustion and HCCI combustion modes can coexist in the operational range of a conventional diesel or spark ignition engine. The combination of the two combustion modes in one engine provides an engine that operates over the entire typical engine operating range, but has the capability of using HCCI combustion at least in part within appropriate load ranges, to achieve emission levels lower than that previously possible in dual-mode engines.

The following description explains how an engine, using the apparatus 5 embodying the present invention, operates in the diesel combustion mode, the HCCI combustion mode, and in transition between modes of combustion.

### All-Cylinder Spark Ignition or Diesel Combustion Mode

Diesel engine combustion occurs when fuel is injected into the combustion chamber 10a, 10b, 10c or 10d, at near top dead center (TDC), and spontaneously ignites due to the high cylinder gas temperature. The fuel burns as a diffusion flame near stoichiometry for the diesel combustion event. The high flame temperatures generally produce high nitrous oxide emissions, which may be advantageously reduced by the use of exhaust gas circulation. Diluents such as exhaust gas recirculation (EGR) and/or water injection can be used in a diesel engine to control peak combustion temperature and therefore lower the nitrous oxide emission. The in-cylinder fuel injectors 14a, 14b, 14c and 14d may be adapted, as described in U.S. Pat. No. 5,875,743, to inject water and/or fuel directly into the combustion chamber 10a, 10b, 10c or 10d. When operating in a relatively light load range, as represented by the area 420 in the speed-load graph shown in FIG. 4, the EGR intake valves 23a, 23b, 23c and 23d may be modulated to control the amount of exhaust gas recirculated to the intake ports 20a, 20b, 20c and 20d. Exhaust gas recirculation limits peak flame temperature and thus can reduce nitrous oxide emissions.

Spark-ignition combustion occurs when fuel is injected through intake port injectors 12a, 12b, 12c and 12d into the intake ports 20a, 20b, 20c and 20d to create fuel-air mixtures sufficiently rich to support combustion via flame propagation. The mixtures are then passed into cylinders 10a, 10b, 10c and 10d during the cylinders' intake strokes. Alternatively, a preferably stratified and relatively rich fuel-air mixture is generated by injecting fuel through in-cylinder injectors 14a, 14b, 14c and 14d. However the fuel-air mixture is generated, the temperature and/or pressure in cylinders 10a, 10b, 10c and 10d are maintained at levels sufficiently low to prevent compression-triggered ignition. Instead, ignition within each cylinder 10a, 10b, 10c and 10d is triggered by an electric spark and proceeds along a flame front.

The SI and DI modes are controlled by the ECU 16, which is responsive to the aforementioned means of sensing engine operating parameters. The ECU 16 delivers a first electronic signal to the injectors 14a, 14b, 14c and 14d, or alternatively, to the injectors 12a, 12b, 12c and 12d, to inject fuel into the corresponding combustion chambers 10a, 10b, 10c, and 10d in an amount and at a time sufficient to form a nonhomogeneous mixtures of fuel droplets and air in the combustion chambers 10a, 10b, 10c and 10d prior to and optionally also during combustion of the fuel-air charge, in response to sensing engine operating parameters indicative of engine speed and load values within a first or third predefined range, represented by the areas 420 and 450, respectively, in FIG. 4. Also, the ECU 16 may provide electronic signals to other components of the engine apparatus 5 described above to engineer even greater control over the timing, pressure, temperature, diluent ratio, and other operating characteristics that influence combustion within each combustion chamber 10a, 10b, 10c and 10d.

### All-Cylinder HCCI Combustion Mode

HCCI combustion occurs when a lean homogeneous charge of fuel and air begins combustion at or near the end of the engine compression stroke. Homogeneous mixture of fuel and air can be created by using the automotive style port fuel injector 12a, 12b, 12c or 12d, or early (near BDC) direct in-cylinder fuel injection, i.e. early fuel injection, through the in-cylinder fuel injector 14a, 14b, 14c or 14d. The thermodynamic condition and temperature-time relationship of the mixture must be correct for preflame reactions and combustion to occur. Typically, EGR is used in a HCCI combustion mode to raise the intake gas temperature to a level where HCCI combustion will occur. Recirculated exhaust gas is a diluent that can also control combustion rate. HCCI combustion is characterized by multiple combustion sites in a lean charge so that the peak flame temperature is similar to the bulk gas temperature. The resultant low peak flame temperature (relative to conventional diesel diffusion flame combustion) results in nitrous oxide emissions that are 90% to 98% lower than those produced in typical diesel combustion mode operation.

The HCCI combustion mode is controlled in a similar manner as that of the conventional diesel or spark ignition combustion mode. The ECU 16 is connected to a means for sensing engine operating parameters indicative of the engine speed and load, e.g. such as an engine speed sensor (not shown), the intake port temperature and/or pressure sensors 22a, 22b, 22c, and 22d, and an engine coolant temperature sensor (not shown), to calculate the fuel quantity and timing. A wide ratio oxygen sensor (not shown) may also be used to measure oxygen concentration in the exhaust. When the sensed engine operating parameters are indicative of engine speed and load valves within a second predefined range, as represented by the area 430 in FIG. 4, the ECU 16 sends a signal to a means for controllably delivering fuel to the combustion chambers 10a, 10b, 10c and 10d, typically the intake port fuel injectors 12a, 12b, 12c and 12d, whereby fuel is injected into the intake ports 20a, 20b, 20c and 20d in an amount and at a time sufficient to form a homogeneous mixture of fuel and air in the combustion chambers 10a, 10b, 10c and 10d prior to combustion.

Also, the exhaust gas recirculation rate, as well as the ratio of temperature pre-treated air to untreated air may be individually and independently controlled for each intake port 20a, 20b, 20c and 20d to provide favorable intake charge temperatures. Thus, the EGR intake valves 23a, 23b, 23c and 23d; as well as the air intake valves 25a, 25b, 25c and 25d, may be regulated by the ECU 16 to deliver a flow of air, including recirculated exhaust gas, to the corresponding intake port 20a, 20b, 20c and 20d at a rate sufficient to provide a predetermined temperature and diluent ratio for the homogeneous mixture of fuel, air and recirculated exhaust gas in the combustion chamber 10a, 10b, 10c and 10d. Furthermore, the intake air pressure of each intake port 20a, 20b, 20c and 20d may be regulated by the ECU 16 to individually and independently control the charge pressures in the intake ports 20a, 20b, 20c and 20d.

The ECU 16 provides the necessary electronic or other signals to control these engine apparatus components in response to sensing engine operating parameters indicative of engine speed and load valves within the second predefined range, identified by the area 430 in FIG. 4. Also, if desired the sensors 36a, 36b, 36c and 36d may provide feedback to the ECU 16 so that the ECU can alter EGR flow rate and other variables to control the start of combustion and produce efficient, low emission HCCI engine performance. Additionally, if desired, a knock sensor may be used for feedback in the HCCI mode to avoid damaging engine knock.

### Intermediate Bi-Modal Combustion

Bi-modal combustion operation occurs when one or more of the cylinders are operated in HCCI mode, as described above, at the same time as one or more other cylinders are operated in SI or DI mode, as described above. As above, the ECU 16 provides the necessary electronic and control signals to deliver fuel through the intake port injectors of the one or more HCCI-mode cylinders in an amount and time sufficient to form substantially homogeneous mixtures of fuel and air in those cylinders while at the same time delivering fuel through the intake port injectors or in-cylinder injectors of one or more other cylinders operating in SI or DI mode in an amount and time sufficient to form a mixture of fuel and air into the SI/DI mode cylinders in response to sensing engine operating conditions indicative of engine speed and load values within a third predefined range, represented by region 440 in FIG. 4, intermediate the first and second ranges.

Once the engine operating parameters indicative of engine speed, load, temperature and pressure are sensed, various methods may be used to determine at what times and under what circumstances the combustion mode should be switched between DI/SI mode and HCCI combustion mode for the most desirable operation. For example, the engine may be mapped to create a look-up table in the ECU 16 that will define the speed and load ranges at which the engine will run in HCCI mode, and at what speeds and load ranges the engine will begin to switch to the DI or SI mode, and at what speeds and load ranges the engine will operate with some cylinders in HCCI mode and others in DI or SI mode. The look-up table can be updated using an adaptive learning algorithm. Also, model-based control can be used to calculate, on a real-time basis, if conditions are favorable for HCCI or dual-mode operation. Model-based control can also be used to calculate the transition conditions under which the engine should switch, and the rate such switching should progress, between conventional DI or SI and HCCI combustion modes.

SOC and knock sensors 36a, 36b, 36c and 36d can be used for individual cylinder-by-cylinder feedback for all of the above control strategies. The SOC sensor will provide information on start-of-combustion timing and also indicate the lack of combustion or misfire. If early or late combustion is detected, EGR rate, fuel quantity and timing can be changed to optimize the start of combustion. If misfire is determined, the individual cylinder can be further optimized in HCCI mode or switched back to conventional SI or DI mode. If knock is detected from the knock sensor, the engine can either be optimized in HCCI mode or switched back to conventional SI or DI mode.

An illustrative example of the combined HCCI and conventional diesel combustion modes is as follows. The engine will start as a conventional diesel or spark ignition engine, and operate at any demanded speed-load condition (shown in FIG. 4) until the engine is warmed up. The engine will then operate as a conventional diesel or spark ignition engine over the speed and load ranges represented by the areas 420 and 450 on the speed-load graph shown in FIG. 4, which would have predetermined values depending on the application of the engine. When engine-operating conditions are favorable for all-HCCI operation, as represented by the area 430 in FIG. 4, i.e. coolant temperature, intake temperature, engine speed and intake pressure, and, if applicable, the EGR flow rate are all favorable, the engine will switch to the all-HCCI mode. If the homogeneous charge is created using the intake port fuel injectors 12a, 12b, 12c and 12d, the intake port fuel injectors 12a, 12b, 12c and 12d can be switched on and the in-cylinder injectors 14a, 14b, 14c and 14d switched off. If the homogeneous charge is created using the in-cylinder injector 14a, 14b, 14c and 14d, the fuel injection timing will be advanced towards BDC of the intake stroke.

When the engine operating conditions are no longer favorable for all-HCCI operation, but are favorable for partial-HCCI operation, as depicted in engine speed-load region 440, then the one or more, but fewer than all, of the cylinders 10a, 10b, 10c and 10d will be switched into SI/DI mode, preferably in incremental fashion.

The present invention is particularly useful for controlling the combustion phasing and combustion mode switching in dual-mode compression-ignition engines. Although the present invention is described in terms of exemplary embodiments, with specific illustrative arrangements and sensors for controlling various engine operation parameters and combustion modes, those skilled in the art will recognize the changes in those arrangements, types of sensors, and specific control strategies may be made without departing from the spirit of the invention. Such changes are intended to fall within the scope of the following claims. Other aspects, features, and advantages of the invention may be obtained from the study of this disclosure and the drawings, along with the appended claims.

Furthermore, it should be appreciated that continuation, divisional, and continuation-in-part applications from this specification may be pending at the time this patent issues, the claims of which may encompass embodiments and applications that are broader than the appended claims. Accordingly, if there are any embodiments disclosed in the specification that are not literally claimed in the appended claims, such embodiments or elements should not be presumed to be dedicated to the public.

We claim:

1. A method for controlling the combustion mode of a multi-mode combustion engine having a plurality of combustion chambers, the method comprising:
phasing a first of said plurality of combustion chambers from a first combustion mode to a second combustion mode,
phasing a second of said plurality of combustion chambers from the first combustion mode to the second combustion mode,
wherein the phasing of the first combustion chamber is not simultaneous with the phasing of the second combustion chamber, and
wherein one of the first and second combustion modes is substantially homogeneous charge compression ignition, and the other of the first and second combustion modes is drawn from a group consisting of spark ignition and non-homogeneous compression ignition.

2. The method of claim 1, wherein the phasing of the second combustion chamber begins after the phasing of the first combustion chamber has begun.

3. The method of claim 1, wherein the phasing of the second combustion chamber is completed after the phasing of the first combustion chamber has been completed.

4. The method of claim 1, wherein the phasing of the second combustion chamber begins after the phasing of the first combustion chamber has been completed.

5. The method of claim 1, wherein the first combustion mode is substantially homogeneous charge compression ignition.

6. A method for controlling the combustion mode of a multi-mode combustion engine having a plurality of combustion chambers, the method comprising:
switching a first of said plurality of combustion chambers from a first combustion mode to a second combustion mode,
switching a second of said plurality of combustion chambers from the first combustion mode to the second combustion mode,
wherein the switching of the first combustion chamber is not simultaneous with the switching of the second combustion chamber, and
wherein one of the first and second combustion modes is substantially homogeneous charge compression ignition, and the other of the first and second combustion modes is drawn from a group consisting of spark ignition and non-homogeneous compression ignition.

7. The method of claim 6, wherein the first combustion mode is substantially homogeneous charge compression ignition.

8. An apparatus for controlling the combustion mode of a multi-mode combustion engine having a plurality of combustion chambers, comprising:
means for phasing a first of a plurality of combustion chambers from a first combustion mode to a second combustion mode,
means for phasing a second of said plurality of combustion chambers from the first combustion mode to the second combustion mode so that the phasing of the first combustion chamber is not simultaneous with the phasing of the second combustion chamber, and one of the first and second combustion modes is substantially homogeneous charge compression ignition, and the other of the first and second combustion modes is drawn from a group consisting of spark ignition and non-homogeneous compression ignition.

9. The apparatus of claim 8, wherein the phasing of the second combustion chamber begins after the phasing of the first combustion chamber has begun.

10. The apparatus of claim 8, wherein the phasing of the second combustion chamber is completed after the phasing of the first combustion chamber has been completed.

11. The apparatus of claim 8, wherein the phasing of the second combustion chamber begins after the phasing of the first combustion chamber has been completed.

12. The apparatus of claim 8, wherein the first combustion mode is substantially homogeneous charge compression ignition.

13. An apparatus for controlling the combustion mode of a multi-mode combustion engine having a plurality of combustion chambers, comprising:
means for switching a first of a plurality of combustion chambers from a first combustion mode to a second combustion mode,
means for switching a second of said plurality of combustion chambers from the first combustion mode to the second combustion mode so that the switching of the first combustion chamber is not simultaneous with the switching of the second combustion chamber, and so that one of the first and second combustion modes is substantially homogeneous charge compression ignition, and the other of the first and second combustion modes is drawn from a group consisting of spark ignition and non-homogeneous compression ignition.

14. The apparatus of claim 13, wherein the first combustion mode is substantially homogeneous charge compression ignition.

15. A multi-mode combustion engine having a plurality of combustion chambers, the method comprising:
first and second combustion chambers, each formed by an engine body and a piston operable to compress a trapped mixture of fuel and air to pressures sufficient to cause the mixture to auto-ignite,
a first intake port in fluid communication with the first combustion chamber,
a controllable source of air, including oxygen, in fluid communication with the first intake port,
a first intake port injector operable to inject fuel into the first intake port,
a first in-cylinder injector operable to inject fuel into the first combustion chamber,
a second intake port in fluid communication with the second combustion chamber,
the controllable source of air being in fluid communication also with the second intake port,
a second intake port injector operable to inject fuel into the second intake port,
a second in-cylinder injector operable to inject fuel into the second combustion chamber,
a sensor that senses engine operating conditions indicative of the engine speed and load, and
an engine control unit communicatively coupled to the sensor,
the engine control unit also being communicatively coupled to the in-cylinder injectors and the intake port injectors, the engine control unit being operable to control the volume and timing of fuel injected into the in-cylinder injectors and the intake port injectors,
the engine control unit being adapted to deliver electronic signals to controllably deliver fuel through the first and second intake port injectors in amounts and times sufficient to form substantially homogeneous mixtures of fuel and air in the first and second combustion chambers in response to sensing engine operating conditions indicative of engine speed and load values within a first predefined range, and deliver fuel through the first and second in-cylinder injectors in amounts and times sufficient to form substantially nonhomogeneous mixtures of fuel and air into the first and second combustion chambers in response to sensing engine operating conditions indicative of engine speed and load values within a second predefined range, and deliver fuel through the first intake port injector in an amount and time sufficient to form a substantially homogeneous mixture of fuel and air in the first combustion chamber while at the same time delivering fuel through the second in-cylinder injector in an amount and time sufficient to form a substantially non-homogeneous mixture of fuel and air into the second combustion chamber in response to sensing engine operating conditions indicative of engine speed and load values within a third predefined range intermediate the first and second ranges.

16. The engine of claim 15, wherein the engine control unit is communicatively coupled with a controllable source of air, the engine control unit being operable to independently control the air flow entering the first and second intake ports.

17. The engine of claim 15, further comprising a first exhaust port in fluid communication with the first combustion chamber.

18. The engine of claim 17, further comprising an exhaust gas recirculation port fluidly connecting the first exhaust port to the controllable source of air.

19. The engine of claim 18, further comprising a first exhaust gas recirculation valve that governs the egress of exhaust gas from the first exhaust port to the exhaust recirculation gas port.

20. The engine of claim 19, further comprising:
a second exhaust port in fluid communication with the second combustion chamber, and
a second exhaust gas recirculation valve to permit the egress of gas from the second exhaust port into the exhaust gas recirculation port.

21. The engine of claim 20, wherein the controllable source of air comprises:
a first exhaust gas inlet valve fluidly connecting the exhaust gas recirculation port to the first intake port to govern the reintroduction of exhaust gas into the first intake port.

22. The engine of claim 21, wherein the controllable source of air further comprises:
a second exhaust gas inlet valve fluidly connecting the exhaust gas recirculation port to the second intake port to govern the reintroduction of exhaust gas into the second intake port.

23. The engine of claim 21, wherein the engine control unit is communicatively coupled to each of the exhaust gas recirculation valves, the engine control unit being adapted to deliver signals to open exhaust gas recirculation valves in fluid communication with combustion chambers that are operating in substantially homogeneous charge compression ignition mode and to close exhaust gas recirculation valves in fluid communication with combustion chambers that are not operating in substantially homogeneous charge compression ignition mode.

24. An apparatus for controlling the combustion mode of a multi-mode combustion engine having a plurality of combustion chambers, the apparatus comprising:
independently controllable means for delivering fuel to each combustion chamber;
means for sensing engine operating parameters indicative of the engine speed and load; and
an engine control unit communicatively coupled to the means for controllably delivering fuel to said combustion chambers and with said means for sensing engine operating parameters indicative of the engine speed and load, the engine control unit being adapted to deliver signals to controllably deliver fuel through the first and second intake port injectors in amounts and times sufficient to form substantially homogeneous mixtures of fuel and air in the first and second combustion chambers in response to sensing engine operating conditions indicative of engine speed and load values within a first predefined range, and deliver fuel through the first and second in-cylinder injectors in amounts and times sufficient to form substantially non-homogeneous mixtures of fuel and air into the first and second combustion chambers in response to sensing engine operating conditions indicative of engine speed and load values within a second predefined range, and deliver fuel through the first intake port injector in an amount and time sufficient to form a substantially homogeneous mixture of fuel and air in the first combustion chamber while at the same time delivering fuel through the second in-cylinder injector in an amount and time sufficient to form a substantially non-homogeneous mixture of fuel and air into the second combustion chamber in response to sensing engine operating conditions indicative of engine speed and load values within a third predefined range intermediate the first and second ranges.
